(19) United States
(12) Patent Application Publication
(10) Pub. No.: US 2017/0314562 A1
(43) Pub. Date: Nov. 2, 2017

(54) EFFICIENT LOW PRESSURE RATIO PROPULSOR STAGE FOR GAS TURBINE ENGINES

(71) Applicant: United Technologies Corporation, Farmington, CT (US)

(72) Inventor: Becky E. Rose, Colchester, CT (US)

(21) Appl. No.: 15/143,412

(22) Filed: Apr. 29, 2016

(51) Int. Cl. F04D 25/02; F02K 3/06; F04D 29/32

(52) U.S. Cl. CPC F04D 25/024; F04D 29/321; F02K 3/06; F05B 2230/00; F05D 2260/4031; F05B 2220/303

(57) ABSTRACT

A propulsor for a gas turbine engine includes, among other things, a case including a duct disposed along an axis to define a flow path. A rotor includes a row of propulsor blades extending in a generally radial direction outwardly from a hub, the hub rotatable about the axis such that the propulsor blades deliver airflow into the flow path. A row of guide vanes are situated in the flow path. At least two of the guide vanes extend in the generally radial direction between inner and outer surfaces of the duct, extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes. The row of guide vanes has a vane solidity (VR) defined as VCD/VCP, the vane solidity (VR) being equal to or less than 1.43.

### BACKGROUND

This disclosure relates generally to a propulsor for gas turbine engines, and more particularly to a propulsor having a low solidity guide vane arrangement.

Gas turbine engines can include a propulsor, a compressor section, a combustor section and a turbine section. The propulsor includes fan blades for compressing a portion of incoming air to produce thrust and also for delivering a portion of air to the compressor section. Air entering the compressor section is compressed and delivered into the combustor section where it is mixed with fuel and ignited to generate a high-speed exhaust gas flow. The high-speed exhaust gas flow expands through the turbine section to drive the compressor section and the propulsor.

Some propulsors include guide vanes positioned in a bypass flow path downstream of the fan blades. The guide vanes direct the bypass airflow from the fan blades before being ejected from the bypass flow path.

### SUMMARY

A propulsor for a gas turbine engine according to an exemplary aspect of the present disclosure includes a case including a duct disposed along an axis to define a flow path, a rotor including a row of propulsor blades extending in a generally radial direction outwardly from a hub, the hub rotatable about the axis such that the propulsor blades deliver airflow into the flow path, and a row of guide vanes situated in the flow path. At least two of the guide vanes extend in the generally radial direction between inner and outer surfaces of the duct, extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes. The row of guide vanes has a vane solidity (VR) defined as VCD/VCP, the vane solidity (VR) being equal to or less than 1.43.

In a further non-limiting embodiment of any of the foregoing propulsor embodiments, the vane solidity (VR) is equal to or greater than 0.7.

In a further non-limiting embodiment of any of the foregoing propulsor embodiments, the row of guide vanes includes a vane quantity (VQ) of guide vanes that is between 14.0 and 40.0.

In a further non-limiting embodiment of any of the foregoing propulsor embodiments, the vane quantity (VQ) is no greater than 38.

In a further non-limiting embodiment of any of the foregoing propulsor embodiments, the vane quantity (VQ) is no less than 20.

In a further non-limiting embodiment of any of the foregoing propulsor embodiments, each of the propulsor blades extends in the generally radial direction outwardly from a root to a tip, extends in the chordwise direction between a second leading edge and a second trailing edge to define a blade chord dimension (BCD) at the tip, and defines a blade circumferential pitch (BCP) at the tip of the corresponding propulsor blade and an adjacent one of the propulsor blades, and the row of propulsor blades has a blade solidity (BR) defined as BCD/BCP, the blade solidity (BR) being between 0.6 and 0.9.

In a further non-limiting embodiment of any of the foregoing propulsor embodiments, the row of guide vanes includes a vane quantity (VQ) of guide vanes, the row of propulsor blades includes a blade quantity (BQ) of propulsor blades, and a ratio of VQ/BQ is between 2.2 and 2.5.

In a further non-limiting embodiment of any of the foregoing propulsor embodiments, the blade quantity (BQ) is no greater than 20.

In a further non-limiting embodiment of any of the foregoing propulsor embodiments, the vane quantity (VQ) is no greater than 38.

In a further non-limiting embodiment of any of the foregoing propulsor embodiments, the first span position corresponds to a midspan of the corresponding guide vane.

A gas turbine engine according to another exemplary aspect of the present disclosure includes a turbine section configured to drive a compressor section, and a propulsor configured to be driven by the turbine section. The propulsor includes a bypass duct defining a bypass flow path, a rotor including a row of propulsor blades extending in a generally radial direction outwardly from a hub, the propulsor blades configured to deliver airflow into the bypass flow path, and a row of guide vanes situated in the bypass flow path. Each of the guide vanes extends generally radially between inner and outer surfaces of the bypass duct, extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes. The row of guide vanes has a vane solidity (VR) defined as VCD/VCP, the vane solidity (VR) being between 0.7 and 1.3.

In a further non-limiting embodiment of any of the foregoing embodiments, the first span position corresponds to a midspan of the corresponding guide vane.

In a further non-limiting embodiment of any of the foregoing embodiments, the row of propulsor blades is configured to define a total pressure ratio across the propulsor blades alone of between 1.1 and 1.35.

In a further non-limiting embodiment of any of the foregoing embodiments, a geared architecture is configured to drive the rotor at a different speed than the turbine section.

In a further non-limiting embodiment of any of the foregoing embodiments, each of the propulsor blades extends in the generally radial direction outwardly from a root to a tip, extends in the chordwise direction between a second leading edge and a second trailing edge to define a blade chord dimension (BCD) at the tip, and defines a blade circumferential pitch (BCP) at the tip of the corresponding propulsor blade and an adjacent one of the propulsor blades. The row of propulsor blades has a blade solidity (BR) defined as BCD/BCP, the blade solidity (BR) being equal to or less than 0.9.

In a further non-limiting embodiment of any of the foregoing embodiments, the row of guide vanes includes a vane quantity (VQ) of guide vanes, the row of propulsor blades includes a blade quantity (BQ) of propulsor blades, and a ratio of VQ/BQ is between 2.2 and 2.5.

In a further non-limiting embodiment of any of the foregoing embodiments, the row of propulsor blades is configured to define a total pressure ratio across the propulsor blades alone of equal to or less than 1.35.

A method of designing a gas turbine engine according to another exemplary aspect of the present disclosure includes providing a turbine section configured to drive a compressor section, and providing a propulsor configured to be driven by the turbine section. The propulsor includes a bypass duct to define a bypass flow path, a rotor including a row of propulsor blades extending in a generally radial direction outwardly from a hub, the propulsor blades configured to deliver airflow into the bypass flow path, and a row of guide vanes situated in the bypass flow path. Each of the guide vanes extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes. The row of guide vanes has a vane solidity (VR) defined as VCD/VCP, the vane solidity (VR) being between 0.7 and 1.2.

In a further non-limiting embodiment of any of the foregoing embodiments, the method includes providing a geared architecture configured to drive the rotor at a different speed than the turbine section. The row of propulsor blades is configured to define a total pressure ratio across the propulsor blades alone of equal to or less than 1.35.

In a further non-limiting embodiment of any of the foregoing embodiments, each of the propulsor blades extends in the chordwise direction between a second leading edge and a second trailing edge to define a blade chord dimension (BCD) at a second span position, and defines a blade circumferential pitch (BCP) at the second span position of the corresponding propulsor blade and an adjacent one of the propulsor blades. The row of propulsor blades has a blade solidity (BR) defined as BCD/BCP, the blade solidity (BR) being between 0.6 and 0.9. The row of guide vanes includes a vane quantity (VQ) of guide vanes, the row of propulsor blades includes a blade quantity (BQ) of propulsor blades, and a ratio of VQ/BQ is less than or equal to 2.5.

These and other features of this disclosure will be better understood upon reading the following specification and drawings, the following of which is a brief description.

### BRIEF DESCRIPTION OF THE DRAWINGS

FIG. 1 illustrates a gas turbine engine.

FIG. 2 is a perspective cutaway view of a propulsor.

FIG. 3A is a schematic view of airfoil span positions for a propulsor blade.

FIG. 3B is a schematic view of airfoil span positions for a guide vane.

FIG. 4 is a schematic view of adjacent propulsor blades and adjacent guide vanes depicting a chord and a leading edge gap, or circumferential pitch of the adjacent propulsor blades and adjacent guide vanes.

### DETAILED DESCRIPTION

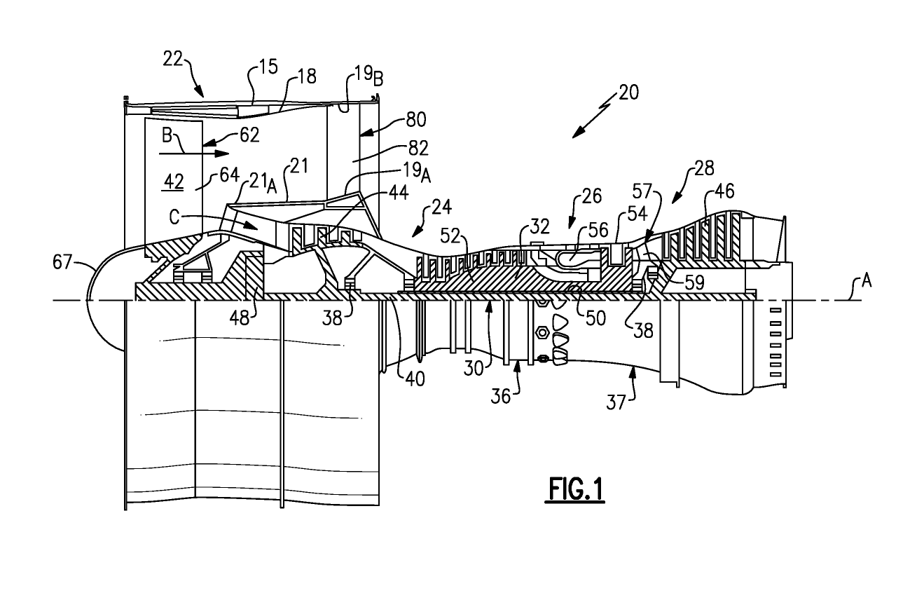

FIG. 1 schematically illustrates a gas turbine engine 20. The gas turbine engine 20 is disclosed herein as a two-spool turbofan that generally incorporates a propulsor or fan section 22, a compressor section 24, a combustor section 26 and a turbine section 28. Alternative engines might include an augmentor section (not shown) among other systems or features. The fan section 22 drives air along a bypass flow path B in a bypass duct 18 defined within a fan case 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than or equal to about six (6), with an example embodiment being greater than about ten (10), the geared architecture 48 is an epicyclic gear train, such as a star gear system, a planetary gear system or other gear system, with a gear reduction ratio of greater than or equal to about 2.3 and the low pressure turbine 46 has a pressure ratio that is greater than about five. In one disclosed embodiment, the engine 20 bypass ratio is greater than or equal to about ten (10:1), the fan diameter is significantly larger than that of the low pressure compressor 44, and the low pressure turbine 46 has a pressure ratio that is greater than about five 5:1. The engine 20 in one example is a high-bypass geared aircraft engine. In another example, the engine 20 bypass ratio is greater than or equal to about twelve (12), the geared architecture 48 has a gear reduction ratio of greater than about 2.6 and the low pressure turbine 46 has a pressure ratio that is greater than about five. In some examples, the bypass ratio is less than or equal to about 40, or more narrowly less than or equal to about 30. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. In examples, the gear reduction ratio is less than about 5.0, or less than about 4.0, such as between about 2.4 and about 3.1. It should be understood, however, that the above parameters are only exemplary of one embodiment of a geared architecture engine and that the present disclosure is applicable to other gas turbine engines including direct drive or non-geared turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than or equal to about 1.50, with an example embodiment being less than or equal to about 1.45. In some examples, the fan pressure ratio is between about 1.1 and about 1.35. For the purposes of this disclosure, the term “pressure ratio” means a ratio of the total pressures exiting the propulsor blades divided by the total pressure measured at the entering of the blade row at a bucket cruise condition. For the purposes of this disclosure, the term “about” means±3% unless otherwise indicated. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1200 ft/second, or more narrowly less than about 1150 ft/second.

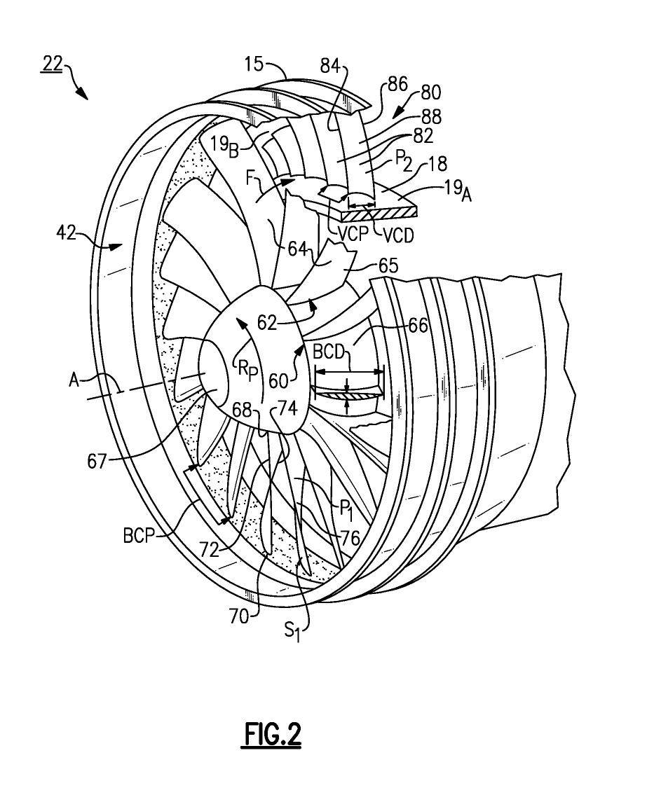

Referring to FIG. 2, a perspective view of the propulsor 22 is shown. The fan 42 includes a rotor 60 having at least one row 62 of airfoils or propulsor blades 64 that are circumferentially distributed about, and are supported by, the hub 66. The hub 66 is rotatable about the engine axis A in a direction R_{P}, which may be clockwise or counter-clockwise. A spinner 67 is supported relative to the hub 66 to provide an aerodynamic inner flow path into the fan section 22.

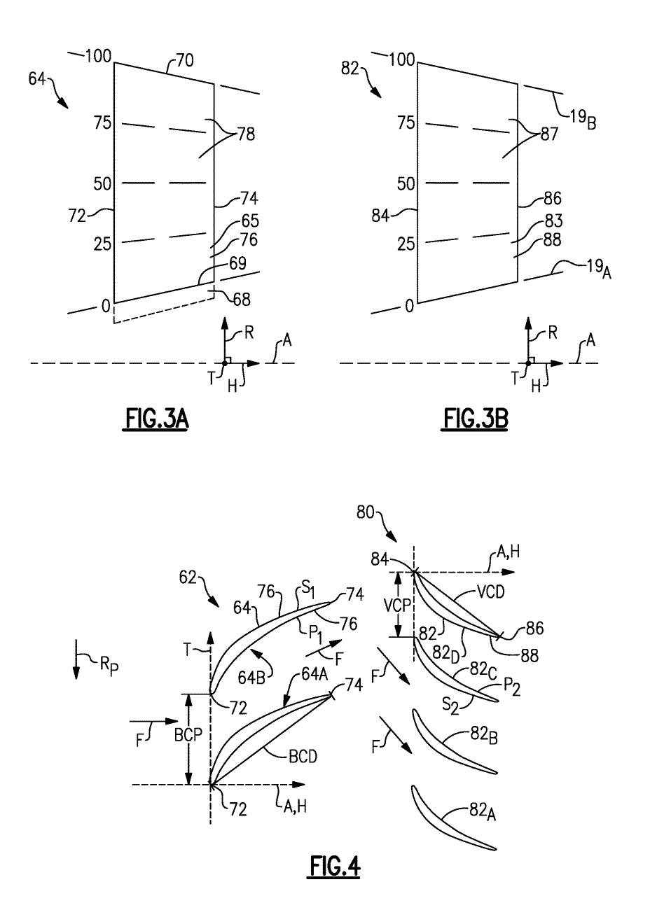

Referring to FIG. 3A, with continuing reference to FIG. 2, each of the propulsor blades 64 includes an airfoil body 65 that extends in a generally spanwise or radial direction R from the hub 66 between a root 68, coupled to the hub 66, and a tip 70. Each airfoil body 65 extends axially in a chordwise direction H between a blade leading edge 72 and a blade trailing edge 74, and extends circumferentially in a thickness direction T between a first pressure side P₁ and a first suction side S₁. For the purposes of this disclosure, the term “generally radial direction” means a direction having a major component that extends generally from or toward an axis of rotation of the propulsor blades 64 and vanes 82, which in the illustrated example coincides with the engine central longitudinal axis A. It should be understood that the generally radial direction R can include a minor component in an axial and/or circumferential directions such that the propulsor blades 64 have a desired amount of sweep and/or lean, for example.

The airfoil body 65 of each propulsor blade 64 has an exterior blade surface 76 providing a contour that extends in the chordwise direction H between the blade leading edge 72 and the blade trailing edge 74. The exterior blade surface 76 generates lift based upon its geometry and directs flow along the core flow path C and bypass flow path B. The propulsor blade 64 may be constructed from a composite material, or an aluminum or titanium alloy, or a combination of one or more of these. Abrasion-resistant coatings or other protective coatings may be applied to the propulsor blade 64.

Referring to FIG. 3B, with continuing reference to FIG. 2, the propulsor 22 includes at least one row 80 of turning or exit guide vanes 82. The guide vanes 82 are positioned in the bypass flow path B axially aft of the row 62 of propulsor blades 64 relative to the engine axis A. Each of the guide vanes 82 includes an airfoil body 83 that extends in the generally spanwise or radial direction R between inner and outer surfaces 19_{A}, 19_{B} of duct 18, axially in the chordwise direction H between a vane leading edge 84 and a vane trailing edge 86, and circumferentially in the thickness direction T between a second pressure side P₂ and a second suction side S₂. The chordwise direction H may be substantially parallel or transverse to the engine axis A. The generally radial direction R can be substantially perpendicular or transverse to the engine axis A. Inner surfaces 19_{A} of the duct 18 can be provided by core engine case 21 at a location downstream of splitter 21A.

The airfoil body 83 of each guide vane 82 has an exterior vane surface 88 providing a contour that extends in the chordwise direction H between the vane leading edge 84 and the vane trailing edge 86. The exterior vane surface 88 can be contoured to direct flow F compressed by the propulsor blades 64 through the bypass flow path B. The guide vanes 82 can be constructed from a metal, metal alloy, or composite material, for example. The guide vanes 82 can serve as a structural component to transfer loads between the fan case 15 and the engine static structure 36. Although the propulsor 22 of FIG. 2 is shown as a single propulsor stage having one row 62 of propulsor blades 64 and one row 80 of guide vanes 82, it should be appreciated that the propulsor 22 can be configured to have more than one row of propulsor blades 64 and/or guide vanes 82 with one or more of the rows (e.g., first or last row) arranged to define any of the quantities disclosed herein.

FIGS. 3A and 3B schematically illustrated span positions of propulsor blade 64 and guide vane 82, respectively. Span positions are schematically illustrated from 0% to 100% in 25% increments, for example, to define a plurality of sections 78 of the propulsor blade 64 and a plurality of sections 87 of the guide vane 82. Each section 78, 87 at a given span position is provided by a conical cut that corresponds to the shape of segments of the bypass flowpath B or the core flow path C, as shown by the large dashed lines.

In the case of a propulsor blade 64 with an integral platform, the 0% span position (or zero span) corresponds to the generally radially innermost location where airfoil body 65 meets the fillet joining the airfoil body 65 to the platform 69. In the case of a propulsor blade 64 without an integral platform, the 0% span position corresponds to the generally radially innermost location where the discrete platform 69 meets the exterior blade surface 76 of the airfoil body 65. A 100% span position (or full span) corresponds to section 78 of the propulsor blade 64 at the tip 70. The 50% position (or midspan) corresponds to a generally radial position halfway between the 0% and 100% span positions of the airfoil body 65.

The guide vane 82 has an airfoil body 83 which extends generally radially between inner and outer surfaces 19_{A}, 19_{B} of the duct 18. The 0% span position corresponds to the generally radially innermost location where the exterior vane surface 88 of the airfoil body 83 meets the inner surfaces 19_{A} of the duct 18. The 100% span position corresponds to the generally radially outermost location where the exterior vane surface 88 of the airfoil body 83 meets the outer surfaces 19_{B} of the duct 18. The 50% span position (or midspan) corresponds to a generally radial position halfway between the 0% and 100% span positions of the airfoil body 83. Airfoil geometric shapes, stacking offsets, chord profiles, stagger angles, axial sweep and dihedral angles, and/or tangential lean angles, bow, or other three-dimensional geometries, among other associated features, can be incorporated individually or collectively to the propulsor blades 64 and/or guide vanes 82 to improve characteristics such as aerodynamic efficiency, structural integrity, and vibration mitigation, for example.

FIG. 4 shows an isolated view of a pair of adjacent propulsor blades 64 of the propulsor 22 designated as blades 64A/64B, and four adjacent guide vanes 82 of the propulsor 22 designated as guide vanes 82A/82B/82C/82D. Each blade 64A/64B is sectioned at a first generally radial position between the root 68 and the tip 70, and each vane 82A/82B/82C/82D is sectioned at a second generally radial position between inner and outer surfaces 19A/19B of the duct 18. The first and second generally radial positions may be the same (e.g., both at 25%, 50% or 100% span) or can differ (e.g., one at 50% and the other at 100% span).

A blade chord, represented by blade chord dimension (BCD), is a straight line that extends between the blade leading edge 72 and the blade trailing edge 74 of the propulsor blade 64. The blade chord dimension (BCD) may vary along the span of the propulsor blade 64. The row 62 of propulsor blades 64 defines a circumferential gap, represented as blade circumferential pitch (BCP), which is equivalent to an arc distance between the blade leading edges 72 of neighboring or adjacent propulsor blades 64 for a corresponding span position. In alternative examples, blade circumferential pitch (BCP) is defined relative to another position along the exterior blade surface 76 of the propulsor blades 64, such as midchord or the blade trailing edges 74.

A vane chord, represented by vane chord dimension (VCD), is a straight line that extends between the vane leading edge 84 and the vane trailing edge 86 of the guide vane 82. The vane chord dimension (VCD) may vary along the span of the guide vane 82. The row 80 of guide vanes 82 defines a circumferential gap, represented as vane circumferential pitch (VCP), which is equivalent to an arc distance between the vane leading edges 84 of neighboring or adjacent guide vanes 82 for a corresponding span position. In alternative examples, vane circumferential pitch (VCP) is defined at another position along the exterior vane surface 88 of the guide vanes 82, such as midchord or the vane trailing edge 86.

Each of the blade circumferential pitch (BCP) and vane circumferential pitch (VCP) is a function of propulsor blade count and guide vane count, respectively. The row 62 of propulsor blades 64 includes a blade quantity (BQ) of propulsor blades, such as 20 or fewer propulsor blades, or more narrowly 16 or fewer propulsor blades. In some examples, the blade quantity (BQ) includes 10 or more blades, or more narrowly between 12 to 18 blades, or between 14 and 16 blades. The row 80 of guide vanes 82 includes a vane quantity (VQ) of guide vanes, such as 40 or fewer guide vanes. In some examples, the vane quantity (VQ) is 38 or fewer guide vanes, or more narrowly 20 or more guide vanes, such as between 32 and 38 guide vanes. In an example, the vane quantity (VQ) is 30 or less guide vanes, such as between 20 and 24 guide vanes. In some examples, the ratio of VQ/BQ is at least about 2.4. In other examples, a ratio of VQ/BQ is between 2.0 and 2.6, or more narrowly between 2.2 and 2.5.

Each of the rows 62, 80 establishes a ratio of chord to gap, which is referred to as solidity. The row 62 of propulsor blades 64 has a blade solidity (BR) defined as BCD/BCP. In some examples, the blade solidity (BR) at tips 70 or full span is equal to or greater than about 0.6 and less than or equal to about 1.1. In further examples, the blade solidity (BR) at full span is equal to or greater than about 0.6, and is less than or equal to about 0.9. The blade solidity (BR) may be substantially the same at each span position, or may differ. In alternative examples, the blade solidity (BR) is taken at a different span position than full span, such as midspan, and can include any of the solidity values disclosed herein. In one example, the blade solidity (BR) is an average solidity at each of the span positions, or an average of a subset of the span positions such as between the 25% and 75% span positions.

The row 80 of guide vanes 82 has a vane solidity (VR) defined as VCD/VCP. The vane solidity (VR) can be calculated throughout the span, and in some embodiments may be defined at the midspan or an average span of the guide vanes 82, for example. In some examples, the vane solidity (VR) at midspan of at least two, or each, of the guide vanes 82 is equal to or greater than about 0.7, or more narrowly equal to or greater than about 0.8, and is less than or equal to about 1.43. In examples, the vane solidity (VR) is less than or equal to about 1.3, or more narrowly less than or equal to about 1.2. In some examples, the vane solidity (VR) at midspan is equal to or greater than about 0.85 or 0.9, more narrowly between about 1.1 and about 1.40, or even more narrowly between about 1.2 and about 1.3. The vane quantity (VQ) can be selected to establish a ratio of VQ/VR that is between about 14.0 and about 40.0, more narrowly less than about 38.0, or between 20.0 and 30.0, for example. The vane solidity (VR) may be substantially the same at each span position, or may differ. In alternative examples, the vane solidity (VR) is taken at a different span position, such as the 100% span position, and can include any of the solidity values disclosed herein. In one example, the vane solidity (BR) is an average solidity at each of the span positions, or an average of a subset of the span positions such as between the 25% and 75% span positions.

In examples, vane solidity (BR) varies in the generally radial direction R and includes any of the quantities disclosed herein. In some examples, the vane solidity (VR) at 0% span and/or 100% span is greater than 1.43, and can be less than 1.5. In other examples, the vane solidity (VR) at 0% span is between about 2.0 and about 3.3, the vane solidity (VR) at midspan is between about 1.14 and about 1.67, such as less than 1.43, and the vane solidity (VR) at 100% span is between about 0.8 and about 1.25.

The low solidity arrangement of the propulsor blades 64 and the guide vanes 82 reduces duct losses, increases aerodynamic performance and propulsive efficiency of the propulsor 22, and reduces the weight of the engine 20, thereby reducing fuel consumption. Engines made with the disclosed architecture, and including propulsor arrangements as set forth in this application, and with modifications coming from the scope of the claims in this application, thus provide very high efficient operation, relatively high stall margins, and are compact and lightweight relative to their thrust capability. Two-spool and three-spool direct drive engine architectures can also benefit from the teachings herein.

It should be understood that relative positional terms such as “forward,” “aft,” “upper,” “lower,” “above,” “below,” and the like are with reference to the normal operational attitude of the vehicle and should not be considered otherwise limiting.

While this invention has been disclosed with reference to one embodiment, it should be understood that certain modifications would come within the scope of this invention. For that reason, the following claims should be studied to determine the true scope and content of this invention.

What is claimed is:

1. A propulsor for a gas turbine engine comprising:
a case including a duct disposed along an axis to define a flow path;
a rotor including a row of propulsor blades extending in a generally radial direction outwardly from a hub, the hub rotatable about the axis such that the propulsor blades deliver airflow into the flow path;
a row of guide vanes situated in the flow path;
wherein at least two of the guide vanes extend in the generally radial direction between inner and outer surfaces of the duct, extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes; and
wherein the row of guide vanes has a vane solidity (VR) defined as VCD/VCP, the vane solidity (VR) being equal to or less than 1.43.

2. The propulsor as set forth in claim 1, wherein the vane solidity (VR) is equal to or greater than 0.7.

3. The propulsor as set forth in claim 1, wherein the row of guide vanes includes a vane quantity (VQ) of guide vanes is between 14.0 and 40.0.

4. The propulsor as set forth in claim 3, wherein the vane quantity (VQ) is no greater than 38.

5. The propulsor as set forth in claim 3, wherein the vane quantity (VQ) is no less than 20.

6. The propulsor as set forth in claim 1, wherein:
each of the propulsor blades extends in the generally radial direction outwardly from a root to a tip, extends in the chordwise direction between a second leading edge and a second trailing edge to define a blade chord dimension (BCD) at the tip, and defines a blade circumferential pitch (BCP) at the tip of the corresponding propulsor blade and an adjacent one of the propulsor blades; and
wherein the row of propulsor blades has a blade solidity (BR) defined as BCD/BCP, the blade solidity (BR) being between 0.6 and 0.9.

7. The propulsor as set forth in claim 6, wherein the row of guide vanes includes a vane quantity (VQ) of guide vanes, the row of propulsor blades includes a blade quantity (BQ) of propulsor blades, and a ratio of VQ/BQ is between 2.2 and 2.5.

8. The propulsor as set forth in claim 7, wherein the blade quantity (BQ) is no greater than 20.

9. The propulsor as set forth in claim 1, wherein the first span position corresponds to a midspan of the corresponding guide vane.

10. The propulsor as set forth in claim 1, wherein the row of propulsor blades is configured to define a total pressure ratio across the propulsor blades alone of between 1.1 and 1.35.

11. A gas turbine engine comprising:
a turbine section configured to drive a compressor section; and
a propulsor configured to be driven by the turbine section, the propulsor comprising:
a bypass duct defining a bypass flow path;
a rotor including a row of propulsor blades extending in a generally radial direction outwardly from a hub, the propulsor blades configured to deliver airflow into the bypass flow path;
a row of guide vanes situated in the bypass flow path;
wherein at least two of the guide vanes extend generally radially between inner and outer surfaces of the bypass duct, extends in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes; and
wherein the row of guide vanes has a vane solidity (VR) defined as VCD/VCP, the vane solidity (VR) being between 0.7 and 1.3.

12. The gas turbine engine as set forth in claim 11, wherein the first span position corresponds to a midspan of the corresponding guide vane.

13. The gas turbine engine as set forth in claim 12, wherein the row of propulsor blades is configured to define a total pressure ratio across the propulsor blades alone of between 1.1 and 1.35.

14. The gas turbine engine as set forth in claim 11, comprising a geared architecture configured to drive the rotor at a different speed than the turbine section.

15. The gas turbine engine as set forth in claim 14, wherein:
each of the propulsor blades extends in the generally radial direction outwardly from a root to a tip, extends in the chordwise direction between a second leading edge and a second trailing edge to define a blade chord dimension (BCD) at the tip, and defines a blade circumferential pitch (BCP) at the tip of the corresponding propulsor blade and an adjacent one of the propulsor blades; and
wherein the row of propulsor blades has a blade solidity (BR) defined as BCD/BCP, the blade solidity (BR) being equal to or less than 0.9.

16. The gas turbine engine as set forth in claim 15, wherein the row of guide vanes includes a vane quantity (VQ) of guide vanes, the row of propulsor blades includes a blade quantity (BQ) of propulsor blades, and a ratio of VQ/BQ is between 2.2 and 2.5.

17. The gas turbine engine as set forth in claim 16, wherein the row of propulsor blades is configured to define a total pressure ratio across the propulsor blades alone of equal to or less than 1.35.

18. A method of designing a gas turbine engine comprising:
providing a turbine section configured to drive a compressor section; and
providing a propulsor configured to be driven by the turbine section, the propulsor comprising:
a bypass duct to define a bypass flow path;
a rotor including a row of propulsor blades extending in a generally radial direction outwardly from a hub, the propulsor blades configured to deliver airflow into the bypass flow path;
a row of guide vanes situated in the bypass flow path;
wherein at least two of the guide vanes extend in a chordwise direction between a first leading edge and a first trailing edge to define a vane chord dimension (VCD) at a first span position of the corresponding guide vane, and defines a vane circumferential pitch (VCP) at the first span position of the corresponding guide vane and an adjacent one of the guide vanes; and
wherein the row of guide vanes has a vane solidity (VR) defined as VCD/VCP, the vane solidity (VR) being between 0.7 and 1.2.

19. The method as set forth in claim 18, comprising:
providing a geared architecture configured to drive the rotor at a different speed than the turbine section; and
wherein the row of propulsor blades is configured to define a total pressure ratio across the propulsor blades alone of equal to or less than 1.35.

20. The method as set forth in claim 18, wherein:
each of the propulsor blades extends in the chordwise direction between a second leading edge and a second trailing edge to define a blade chord dimension (BCD) at a second span position, and defines a blade circumferential pitch (BCP) at the second span position of the corresponding propulsor blade and an adjacent one of the propulsor blades;
wherein the row of propulsor blades has a blade solidity (BR) defined as BCD/BCP, the blade solidity (BR) being between 0.6 and 0.9; and
wherein the row of guide vanes includes a vane quantity (VQ) of guide vanes, the row of propulsor blades includes a blade quantity (BQ) of propulsor blades, and a ratio of VQ/BQ is less than or equal to 2.5.
